(19) United States
(12) Patent Application Publication
(10) Pub. No.: US 2019/0036798 A1
(43) Pub. Date: Jan. 31, 2019

(54) METHOD AND APPARATUS FOR NODE PROCESSING IN DISTRIBUTED SYSTEM

(71) Applicant: Alibaba Group Holding Limited, Grand Cayman (KY)

(72) Inventors: Haiwen Fu, Hangzhou (CN); Siyu Chen, Hangzhou (CN); Guozhao Wu, Hangzhou (CN)

(21) Appl. No.: 16/146,130

(22) Filed: Sep. 28, 2018

Related U.S. Application Data
(63) Continuation of application No. PCT/CN2017/077717, filed on Mar. 22, 2017.

(30) Foreign Application Priority Data
Mar. 31, 2016 (CN) 201610201955.2

(51) Int. Cl. H04L 12/26; H04L 12/24

(52) U.S. Cl. CPC H04L 43/0817; H04L 41/0659; H04L 43/0882

(57) ABSTRACT

A method including acquiring survival state information of the service nodes; acquiring current system information of the central node; determining, by using the survival state information and the current system information, whether there is an abnormality of the service node; acquiring central state information of the central node if there is an abnormality of the service node; and processing the abnormal service node according to the central state information. The example embodiments of the present disclosure integrate a state of the central node to adaptively process an abnormal service node, thereby reducing wrong determination of a service node state due to problems of the central node and reducing an error probability of the central node.

### CROSS REFERENCE TO RELATED PATENT APPLICATIONS

This application claims priority to and is a continuation of PCT Patent Application No. PCT/CN2017/077717, filed on 22 Mar. 2017, which claims priority to Chinese Patent Application No. 201610201955.2 filed on 31 Mar. 2016 and entitled “METHOD AND APPARATUS FOR NODE PROCESSING IN DISTRIBUTED SYSTEM”, which are incorporated herein by reference in their entirety.

### TECHNICAL FIELD

The present disclosure relates to the field of data processing technologies, and, more particularly, to methods and apparatuses for processing nodes in a distributed system.

### BACKGROUND

A distributed system is a system including one or more independent nodes that are geographically and physically scattered. The nodes include service nodes and a central node. The central node may coordinate the service nodes. The nodes may be connected together to share resources. The distributed system is equivalent to a unified whole.

In a running process of the distributed system, it is a very important link to monitor survival states of the service nodes. A common approach is that each service node in the distributed system sends survival state information to the central node at an interval of a preset cycle. After receiving the survival state information, the central node updates its state information table by using the survival state information. The state information table records the latest update time and a next update time of each service node. In order to monitor the survival states of the service nodes, the central node will view the state information table from time to time to confirm the survival states of the service nodes. If the central node finds that the next update time of a service node is less than the current system time, the service node is determined to be in an abnormal state.

FIG. 1 shows a schematic diagram of a working process of a central node 102 and a plurality of service nodes, such as service node 104(1), service node 104(2), service node 104(3), . . . , service node 104(n), in a distributed system, in which n may be any integer. The central node 102 of the system may manage and control the service node 104(1), service node 104(2), service node 104(3), . . . , service node 104(n). The service nodes will report their survival state information to the central node 102 periodically. The central node 102 confirms survival states of the service nodes according to the survival state information, updates the state information table 106 according to the reported survival state information of the service nodes, and performs a failure processing procedure if a failed service node is found. However, it is possible that the central node 102 cannot receive the survival state information reported by the service nodes due to a network delay or cannot process the survival state information in time due to an excessively high system resource load. All these situations may result in problems such as loss of the survival state information of the service nodes or invalidation of the next update time. In such cases, the central node may incorrectly determine the survival state of the service node.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In view of the foregoing problems, example embodiments of the present disclosure are proposed to provide a method for processing nodes in a distributed system and a corresponding apparatus for processing nodes in a distributed system that solve or at least partially solve the foregoing problems.

In order to solve the foregoing problems, an example embodiment of the present disclosure discloses a method for processing nodes in a distributed system, wherein the nodes include service nodes and a central node, and the method includes:

acquiring survival state information of a service node;

acquiring current system information of the central node;

determining, by using the survival state information and the current system information, whether there is an abnormality of the service node;

acquiring central state information of the central node if there is an abnormality of the service node; and

processing the abnormal service node according to the central state information.

For example, the distributed system includes a state information table, and the step of acquiring survival state information of the service nodes includes:

receiving the survival state information uploaded by the service node; and

updating the state information table by using the survival state information of the service node.

For example, the survival state information includes a next update time of the service node, the current system information includes a current system time of the central node, and the step of determining, by using the survival state information and the current system information, whether there is an abnormality of the service node includes:

traversing to find the next update time of the service node in the state information table when a preset time arrives; and

determining, by using the next update time and the current system time, whether there is an abnormality of the service node.

For example, the step of determining, by using the next update time and the current system time, whether there is an abnormality of the service node includes:

determining whether the next update time is less than the current system time;

if yes, determining that there is an abnormality of the service node; and

if no, determining that there is no abnormality of the service node.

For example, the central state information includes network busyness status data and/or system resource usage status data, and the step of processing the abnormal service node according to the central state information includes:

determining, by using the network busyness status data and/or the system resource usage status data, whether the central node is overloaded; and

if yes, updating the survival state information of the abnormal service node in the state information table.

For example, the network busyness status data includes network throughput and a network packet loss rate, the system resource usage status data includes an average load of the system, and the step of determining, by using the network busyness status data and/or the system resource usage status data, whether the central node is overloaded includes:

determining whether the network throughput is greater than or equal to a network bandwidth;

determining whether the network packet loss rate is greater than a preset packet loss rate;

determining whether the average load of the system is greater than a preset load threshold; and

determining that the central node is overloaded if the network throughput is greater than or equal to the network bandwidth, and/or the network packet loss rate is greater than the preset packet loss rate, and/or the average load of the system is greater than the preset load threshold.

For example, the step of updating the survival state information of the abnormal service node in the state information table includes:

extending the next update time of the abnormal service node in the state information table.

For example, the step of updating the survival state information of the abnormal service node in the state information table includes:

sending an update request to the service node;

receiving new survival state information that is uploaded by the service node with respect to the update request, the new survival state information including a new next update time; and

updating the next update time of the abnormal service node in the state information table by using the new next update time.

For example, the method further includes:

treating the service node as a failed service node if there is abnormality of the service node.

For example, after the step of treating the service node as a failed service node, the method further includes:

deleting the failed service node from the central node; and

notifying other service nodes in the distributed system of the failed service node.

An example embodiment of the present disclosure further discloses an apparatus for processing nodes in a distributed system, wherein the nodes include service nodes and a central node, and the apparatus includes:

a survival state information acquisition module configured to acquire survival state information of a service node;

a current system information acquisition module configured to acquire current system information of the central node;

a service node abnormality determining module configured to determine, by using the survival state information and the current system information, whether there is an abnormality of the service node; and call a central state information acquisition module if there is an abnormality of the service node;

the central state information acquisition module configured to acquire central state information of the central node; and

an abnormal service node processing module configured to process the abnormal service node according to the central state information.

For example, the distributed system includes a state information table, and the survival state information acquisition module includes:

a survival state information receiving sub-module configured to receive the survival state information uploaded by the service nodes; and

a first state information table update sub-module configured to update the state information table by using the survival state information of the service nodes.

For example, the survival state information includes a next update time of the service node, the current system information includes a current system time of the central node, and the service node abnormality determining module includes:

a state information table traversing sub-module configured to traverse next update time in the state information table when a preset time arrives; and

a service node abnormality determining sub-module configured to determine, by using the next update time and the current system time, whether there is an abnormality of the service node.

For example, the service node abnormality determining sub-module includes:

a time determination unit configured to determine whether the next update time is less than the current system time; if yes, call a first determining unit; and if no, call a second determining unit;

the first determining unit configured to determine that there is an abnormality of the service node; and

the second determining unit configured to determine that there is no abnormality of the service node.

For example, the central state information includes network busyness status data and/or system resource usage status data, and the abnormal service node processing module includes:

a central node state determining sub-module configured to determine, by using the network busyness status data and/or the system resource usage status data, whether the central node is overloaded; and if yes, call a second state information table update sub-module; and

the second state information table update sub-module configured to update the survival state information of the abnormal service node in the state information table.

For example, the network busyness status data includes network throughput and a network packet loss rate, the system resource usage status data includes an average load of the system, and the central node state determining sub-module includes:

a first network busyness status determination unit configured to determine whether the network throughput is greater than or equal to a network bandwidth;

a second network busyness status determination unit configured to determine whether the network packet loss rate is greater than a preset packet loss rate;

a system resource usage status determination unit configured to determine whether the average load of the system is greater than a preset load threshold; and

a central node load determining unit configured to determine that the central node is overloaded when the network throughput is greater than or equal to the network bandwidth, and/or the network packet loss rate is greater than the preset packet loss rate, and/or the average load of the system is greater than the preset load threshold.

For example, the second state information table update sub-module includes:

a next update time extension unit configured to extend the next update time of the abnormal service node in the state information table.

For example, the second state information table update sub-module includes:

an update request sending unit configured to send an update request to the service node;

a next update time receiving unit configured to receive new survival state information that is uploaded by the service node with respect to the update request, the new survival state information comprising a new next update time; and

a next update time updating unit configured to update the next update time of the abnormal service node in the state information table by using the new next update time.

For example, the apparatus further includes:

a failed service node determining module configured to use the service node as a failed service node if there is no abnormality of the service node.

For example, the apparatus further includes:

a failed service node deletion module configured to delete the failed service node from the central node; and

a failed service node notification module configured to notify other service nodes in the distributed system of the failed service node.

The example embodiments of the present disclosure include the following advantages:

In a distributed system in the example embodiments of the present disclosure, a central node confirms, according to survival state information reported by service nodes and current system information of the central node, whether there is an abnormality of the service node. When there is an abnormality of the service node, the central node will further process the abnormal service node according to state information of the central node. The example embodiments of the present disclosure may comprehensively consider a state of the central node to adaptively process an abnormal service node, thus reducing wrong determination of a service node state due to problems of the central node and reducing an error probability of the central node.

### BRIEF DESCRIPTION OF THE DRAWINGS

The accompanying drawings described herein are provided to further understand the present disclosure and constitute a part of the present disclosure. Example embodiments of the present disclosure and descriptions of the example embodiments are used to explain the present disclosure and do not pose any improper limitations to the present disclosure.

FIG. 1 is a schematic diagram of a working process of a central node and service nodes in a distributed system;

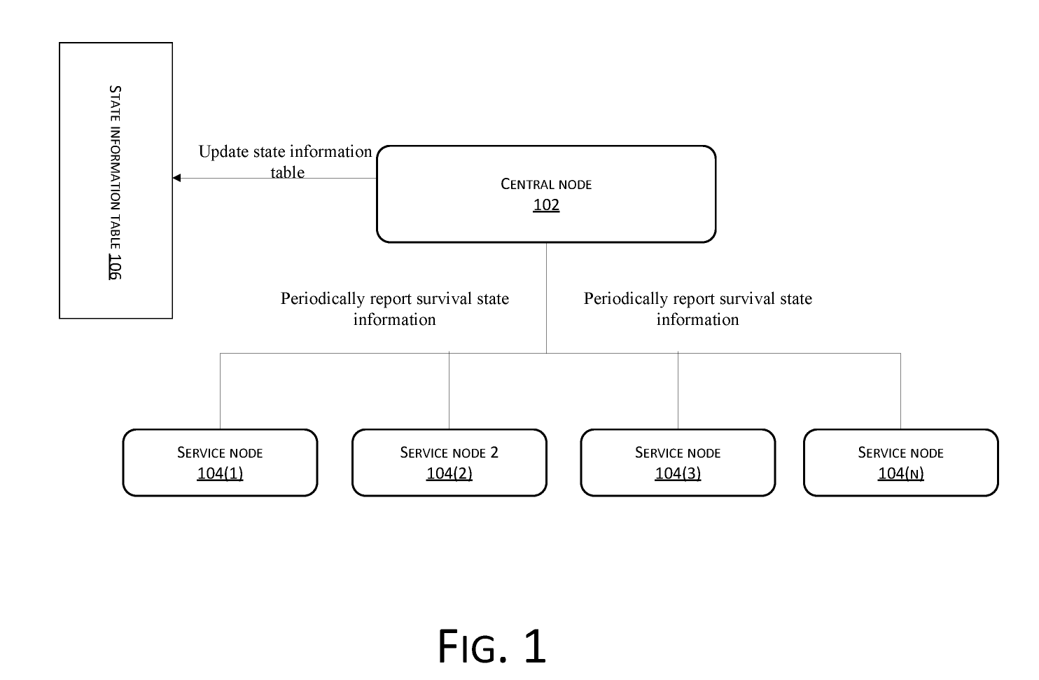

FIG. 2 is a flowchart of steps in Example embodiment 1 of a method for processing nodes in a distributed system according to the present disclosure;

FIG. 3 is a flowchart of steps in Example embodiment 2 of a method for processing nodes in a distributed system according to the present disclosure;

FIG. 4 is a flowchart of working steps of a central node and service nodes in a distributed system according to the present disclosure;

FIG. 5 is a schematic diagram of a working principle of a central node and service nodes in a distributed system according to the present disclosure; and

FIG. 6 is a structural block diagram of an example embodiment of an apparatus for processing nodes in a distributed system according to the present disclosure.

### DETAILED DESCRIPTION

In order to make the foregoing objectives, features and advantages of the present disclosure easier to understand, the present disclosure is described in further detail below with reference to the accompanying drawings and specific implementation manners.

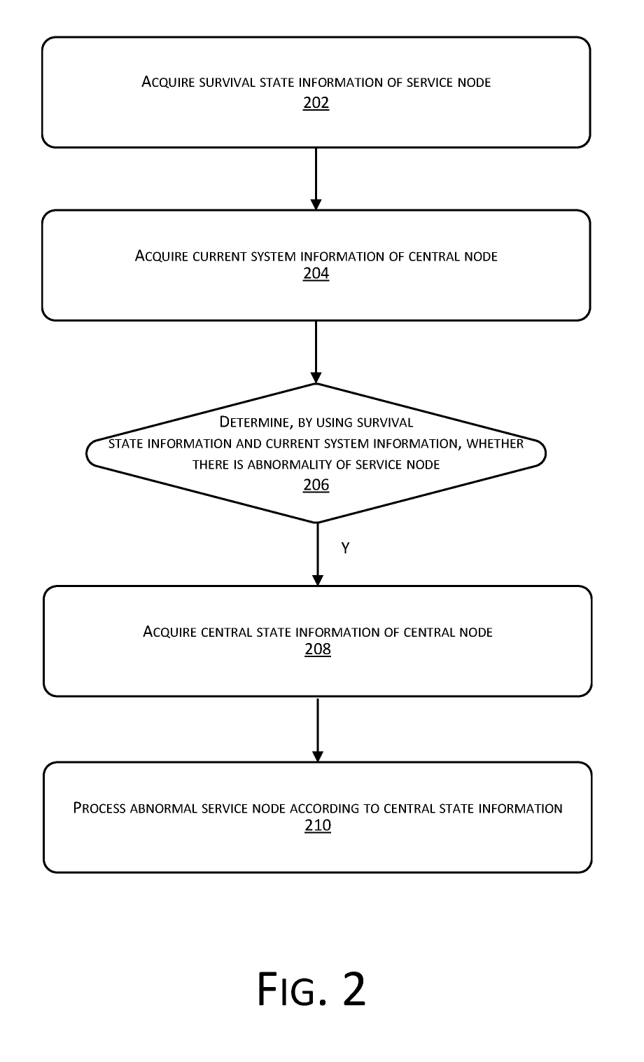

Referring to FIG. 2, a flowchart of steps in Example embodiment 1 of a method for processing nodes in a distributed system according to the present disclosure is shown. The nodes may include service nodes and a central node. The method may specifically include the following steps:

Step 202. Survival state information of a service node is acquired.

In a specific implementation, the service node refers to a node having a storage function or a service processing function in the distributed system, and is generally a device such as a server. The central node refers to a node having a service node coordination function in the distributed system, and is generally a device such as a controller. It should be noted that the example embodiment of the present disclosure is not only applicable to the distributed system but is also applicable to a system in which a node may manage and control other nodes, which is not limited in the example embodiment of the present disclosure.

In an example embodiment of the present disclosure, the distributed system may include a state information table. Step 202 may include the following sub-steps:

Sub-step A. The survival state information uploaded by the service nodes is received.

Sub-step B. The state information table is updated by using the survival state information of the service nodes.

In a specific implementation, the service node is coordinated by the central node. Therefore, the central node needs to know whether the service node works normally. It may be understood that as a device having storage and service functions, the service node needs to execute many tasks. Repeated task execution, system failures and other phenomena may occur in the task executing process because of too many tasks, too small remaining memory and other reasons. Therefore, the service node needs to report survival state information to inform the central node whether there is an abnormality or a failure. The central node will perform corresponding processing according to whether the service node has an abnormality or a failure.

In an example of the present disclosure, the central node stores a state information table. The table is used for storing survival state information that may reflect a survival state of the service node. The service node will periodically report its survival state information. The central node saves the survival state information in the state information table and updates a node state of the service node according to the survival state information. Certainly, the central node may also send a request to the service node when the central node is idle, so as to request the service node to upload its survival state information, which is not limited in the example embodiment of the present disclosure.

Step 204. Current system information of the central node is acquired.

Step 206. The central node determines, by using the survival state information and the current system information, whether there is an abnormality of the service node; and step 208 is performed if there is an abnormality of the service node.

In an example embodiment of the present disclosure, the survival state information may include a next update time of the service node, the current system information may include a current system time of the central node, and step 206 may include the following sub-steps:

Sub-step C. Next update times in the state information table are traversed when a preset time arrives.

Sub-step D. The central node determines, by using the next update times and the current system time, whether there is an abnormal service node among the service nodes.

In an example of the present disclosure, the state information table stores a next update time of the service node. The next update time is reported by the service node to the central node according to a scheduling status of the service node and represents time for next survival state update. For example, the service node determines, according to its own scheduling status, that the next update time is Feb. 24, 2016. If there is no abnormality of the service node, the service node should report the survival state information to the central node before Feb. 24, 2016. In addition, the current system information may include a current system time at which the central node determines whether there is an abnormality of the service node. For example, the current system time may be Feb. 25, 2016.

It should be noted that the foregoing next update time and current system time are merely used as examples. In a specific application, the time unit of the next update time and the current system time may be accurate to hour, minute and second, or rough to month and year, which is not limited in the example embodiment of the present disclosure.

When the preset time arrives, the central node starts to detect whether there is an abnormality of the service node. Specifically, the central node starts to acquire its current system time, traverses next update times in the state information table, and compares each next update time with the current system time, so as to determine whether there is an abnormal service node among the service nodes. A cycle for traversing the state information table may be set to a fixed cycle, for example, 30 seconds, 1 minute, 10 minutes, 20 minutes, or the like; time for traversing may also be determined based on a service requirement.

In an example embodiment of the present disclosure, sub-step D may include the following sub-steps:

Sub-step D1. determining whether the next update time is less than the current system time of a respective service node; if yes, sub-step D2 is performed; if no, sub-step D3 is performed.

Sub-step D2. determining that there is an abnormality of the respective service node.

Sub-step D3. determining that there is no abnormality of the respective service node.

Whether there is an abnormality of the service node may be determined by determining whether the next update time of the service node is less than the current system time of the central node. It may be understood that the next update time is time when the service node reports next survival state information. Therefore, if the next update time is less than the current system time, it indicates that due report time of the service node has passed, and it may be determined that there is an abnormality of the service node. If the next update time is greater than or equal to the current system time, it indicates that the due report time of the service node has not passed yet, and it may be determined that there is no abnormality of the service node.

Step 208. Central state information of the central node is acquired.

Step 210. The abnormal service node is processed according to the central state information.

In the determination of an abnormal service node in the example embodiment of the present disclosure, the state of the central node may also affect the determination of the service node abnormality. Therefore, the abnormal service node may be further processed with reference to the central state information of the central node.

In the distributed system in the example embodiment of the present disclosure, the central node confirms whether there is an abnormality of the service node according to the survival state information reported by the service node and the current system information of the central node. When determining that there is an abnormality of the service node, the central node will further process the abnormal service node according to the central state information of the central node.

The example embodiment of the present disclosure may comprehensively consider a state of the central node to adaptively process an abnormal service node, thus reducing wrong determination of a service node state due to problems of the central node and reducing an error probability of the central node.

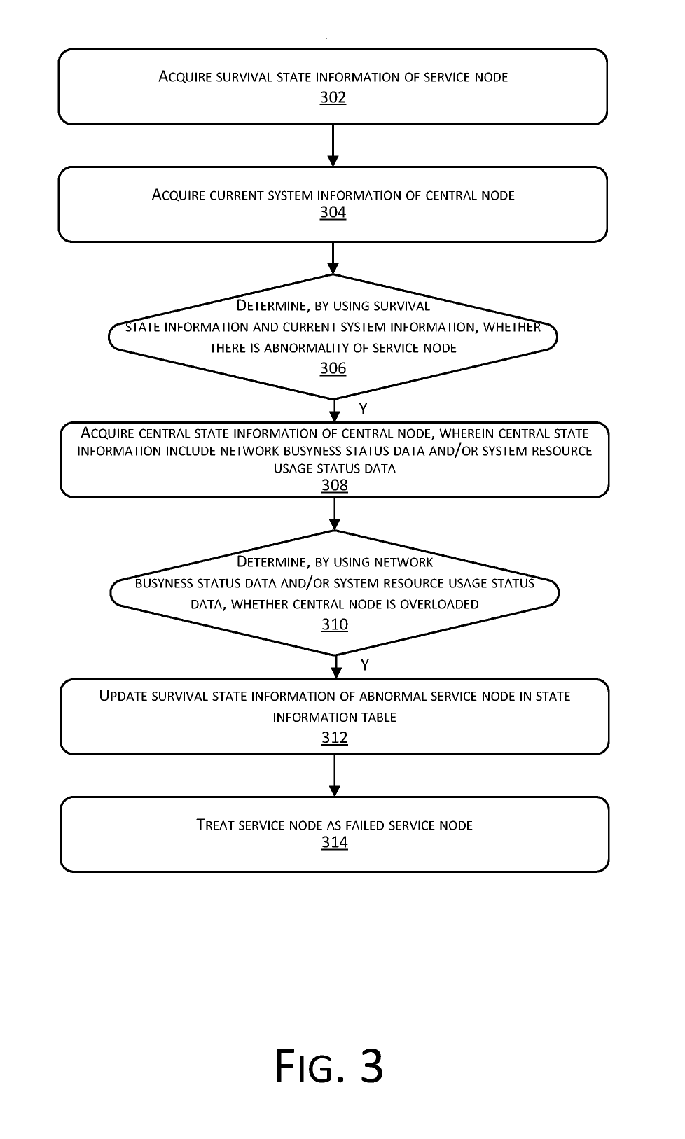

Referring to FIG. 3, a flowchart of steps in Example embodiment 2 of a method for processing nodes in a distributed system according to the present disclosure is shown. The nodes may include service nodes and a central node. The method specifically may include the following steps:

Step 302. Survival state information of the service nodes is acquired.

Step 304. Current system information of the central node is acquired.

Step 306. The central node determines, by using the survival state information and the current system information, whether there is an abnormality of the service node; if there is an abnormality of the service node, step 204 is performed; if there is no abnormality of the service node, step 207 is performed.

Step 308. Central state information of the central node is acquired, wherein the central state information may include network busyness status data and/or system resource usage status data.

Step 310. The central node determines, by using the network busyness status data and/or the system resource usage status data, whether the central node is overloaded; and if yes, step 312 is performed.

In a specific application example of the present disclosure, the network busyness status data may be embodied as network throughput and a network packet loss rate. The system resource usage status data may be embodied as an average load of the system.

Specifically, the network throughput is referred to as throughput for short, and refers to the amount of data that is transmitted successfully through a network (or a channel or node) at any given moment. The throughput depends on a current available bandwidth of the network of the central node, and is limited by the network bandwidth. The throughput is usually an important indicator for a network test performed in actual network engineering, and for example, may be used for measuring performance of a network device. The network packet loss rate refers to a ratio of the amount of lost data to the amount of sent data. The packet loss rate is correlated to network load, data length, data sending frequency, and so on. The average load of the system refers to an average quantity of processes in queues run by the central node in a particular time interval.

In an example embodiment of the present disclosure, step 310 may include the following sub-steps:

Sub-step E. determining whether the network throughput is greater than or equal to a network bandwidth.

Sub-step F. determining whether the network packet loss rate is greater than a preset packet loss rate.

Sub-step G. determining whether the average load of the system is greater than a preset load threshold; sub-step H is performed if the network throughput is greater than or equal to the network bandwidth, and/or the network packet loss rate is greater than the preset packet loss rate, and/or the average load of the system is greater than the preset load threshold.

Sub-step H. determining that the central node is overloaded.

In a specific application example of the present disclosure, a formula for calculating the network busyness status of the central node is as follows:

network throughput>bandwidth, or network packet loss rate>N %;

wherein a value range of N is: 1-100.

A formula for calculating the system resource usage status of the central node is as follows:

system resource usage status=system average load value>N;

wherein N is an integer, and generally, N>1.

In the example embodiment of the present disclosure, the determination is made based on the network busyness status data and the system resource usage status data of the central node. If some or all of the data reach some critical values, it indicates that the central node is overloaded. In this case, a service node that is previously determined as abnormal by the central node is not necessarily a failed service node. Then, the next update time of the service node needs to be extended. If no data reaches the critical values, it indicates that the load of the central node is normal. In this case, the service node that is previously determined as abnormal by the central node should be a failed service node. As such, by taking the state of the central node into consideration, wrong determination about the service node due to problems of the central node may be reduced.

Step 312. The survival state information of the abnormal service node in the state information table is updated.

In an example embodiment of the present disclosure, step 312 may include the following sub-steps:

Sub-step I. The next update time of the abnormal service node in the state information table is extended.

In the example embodiment of the present disclosure, the central node determines, with reference to the network busyness status and the system resource usage status of the central node, whether there is a failure among the service nodes. If the network is very busy or the system resources are very busy, the failure determination made by the central node for the service nodes is less credible. For example, update of survival states of the service nodes in the state information table may fail due to busyness of resources. In this case, the determination made by the central node may be not accepted, and processing of the central node is determined as failed. Meanwhile, in the state information table, the next update time of the service node that is previously determined as abnormal is extended correspondingly.

In an example embodiment of the present disclosure, step 312 may include the following sub-steps:

Sub-step J. An update request is sent to the service node.

Sub-step K. New survival state information that is uploaded by the service node with respect to the update request is received, the new survival state information including a new next update time.

Sub-step L. The next update time of the abnormal service node in the state information table is updated by using the new next update time.

The central node may automatically extend the next update time of the service node according to the state of the central node, or proactively initiates a state update request to the service node to extend the next update time of the service node, thus reducing wrong determination of the service node state due to problems of the central node.

In an example of the present disclosure, for the next update time of a service node that is previously determined as abnormal, the central node may send an update request to the service node. After receiving the request, the service node reports a new next update time according to a task scheduling status of the service node. The central node updates the state information table by using the new next update time to extend the next update time of the service node.

Step 314. The service node is used as a failed service node.

In an example embodiment of the present disclosure, after the step of treating the service node as a failed service node, the method further includes:

deleting the failed service node from the central node; and

notifying other service nodes in the distributed system of the failed service node.

In the example embodiment of the present disclosure, if the service node is determined as failed, related information, such as a registration table, of the failed service node may be deleted from the central node. In addition, other service nodes in the distributed system may be notified of the related information of the failed service node, such as an IP address of the failed service node. After receiving the notification, the service node may locally clear the related information of the failed service node.

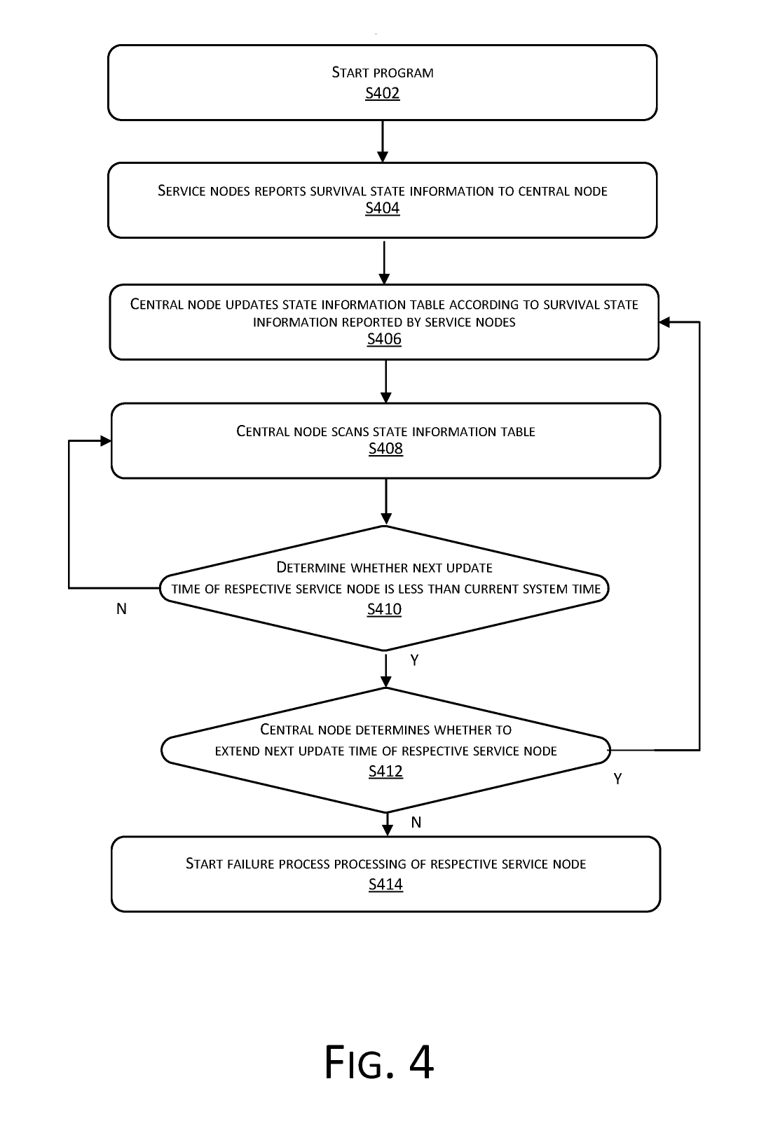

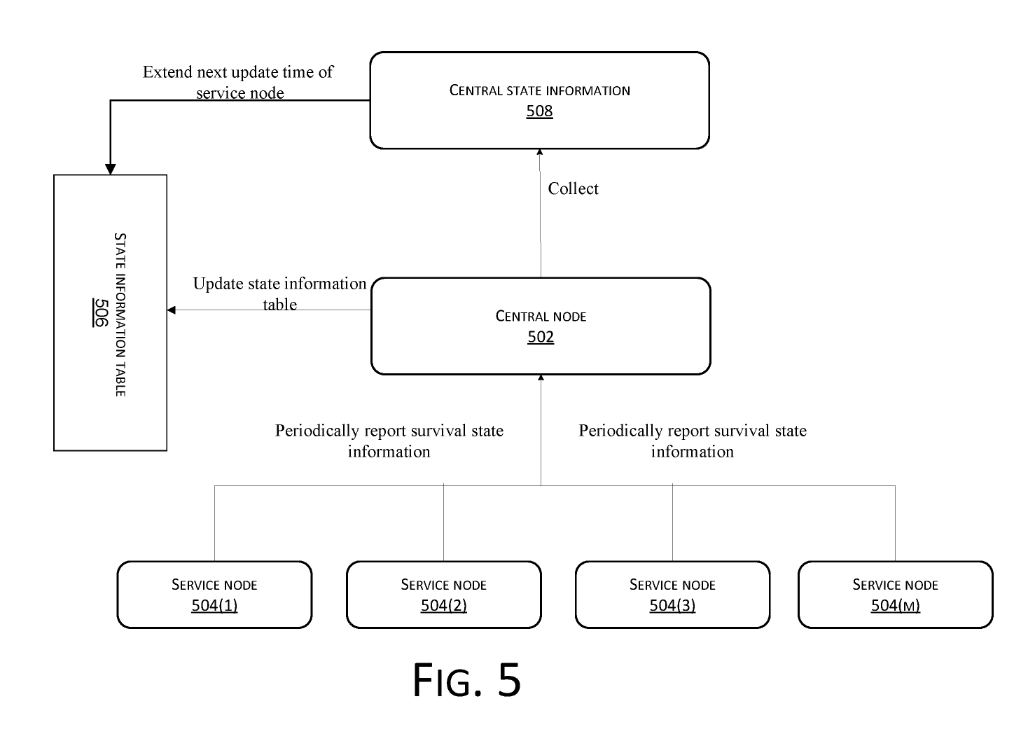

To help those skilled in the art better understand the example embodiment of the present disclosure, a monitoring and processing manner of node states in a distributed system is described below by using a specific example. FIG. 4 shows a schematic diagram of a working process of a central node and service nodes in a distributed system according to the present disclosure, and FIG. 5 shows a schematic diagram of a working principle of a central node and service nodes in a distributed system. Specific steps are shown as follows:

S402. A program is started.

S404. The service nodes report survival state information to the central node.

S406. The central node updates a state information table according to the survival state information of the service nodes, update content including: the latest update time and a next update time.

S408. The central node scans the state information table.

S410. The central node determines whether a next update time of a service node is less than a current system time; if yes, S412 is performed; if no, S408 is performed again to continue scanning the state information table.

S412. The central node determines a network busyness status and a system resource usage status of the central node; if the network is very busy or the system resources are busy, the next update time of the service node in the state information table is extended.

S414. Failure process processing of the service node is started.

In the example embodiment of the present disclosure, the central node determines, with reference to its own state, whether there is an abnormality of the service node, thus reducing wrong determination caused by that the node state information table is not updated due to the network congestion or system resource problem of the central node, and reducing an error probability of the central node.

It should be noted that for ease of description, the foregoing method example embodiments are all described as a series of action combinations. However, those skilled in the art should understand that the example embodiments of the present disclosure are not limited to the described sequence of the actions, because some steps may be performed in another sequence or at the same time according to the example embodiments of the present disclosure. In addition, those skilled in the art should also understand that the example embodiments described in this specification all belong to example embodiments, and the involved actions are not necessarily mandatory to the example embodiments of the present disclosure.

FIG. 5 shows a schematic diagram of a working process of a central node 502 and a plurality of service nodes, such as service node 504(1), service node 504(2), service node 504(3), . . . , service node 504(m), in a distributed system, in which m may be any integer. The central node 502 of the system may manage and control the service nodes. The service nodes will report their survival state information to the central node 502 periodically. The central node 502 confirms survival states of the service nodes according to the survival state information, and updates the state information table 506 according to the reported survival state information of the service nodes.

The central node 502 collects the central state information 508 of the central node. The central node 502 determines whether a next update time of a service node is less than a current system time; if yes, the central node 502 determines a network busyness status and a system resource usage status of the central node 502; if the network is very busy or the system resources are busy, the next update time of the service node in the survival state information is extended.

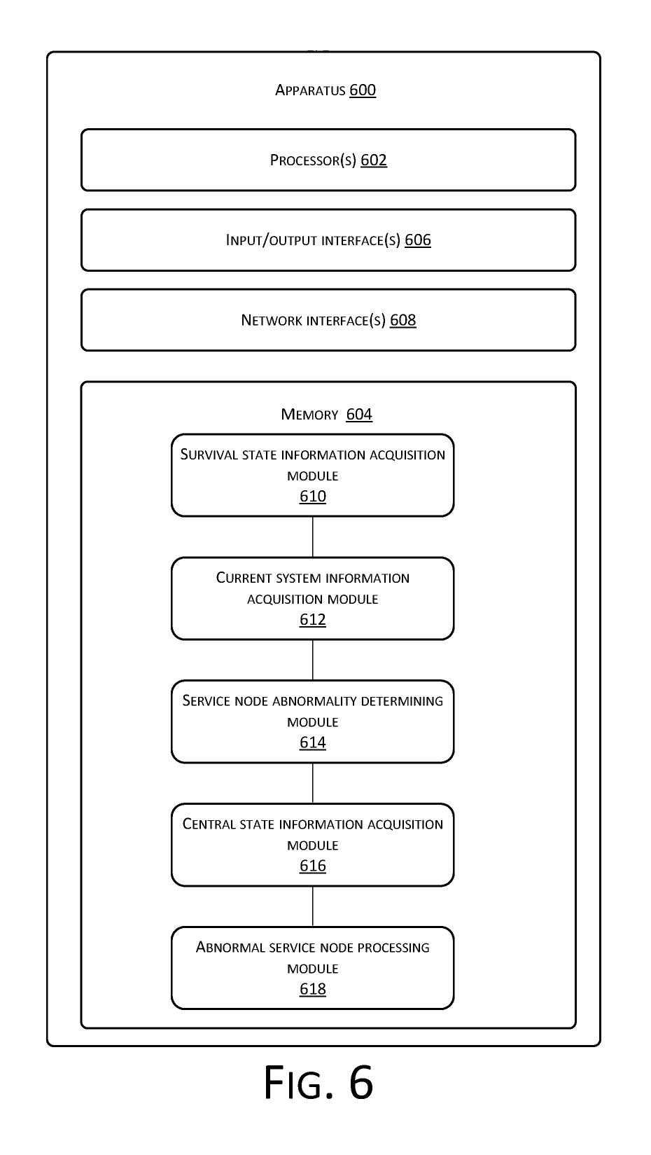

Referring to FIG. 6, a structural block diagram of an example embodiment of an apparatus 600 for processing nodes in a distributed system according to the present disclosure is shown. The nodes include service nodes and a central node. The apparatus 600 includes one or more processor(s) 602 or data processing unit(s) and memory 604. The apparatus 600 may further include one or more input/output interface(s) 606 and one or more network interface(s) 608.

The memory 604 is an example of computer readable medium. The memory 604 may store therein a plurality of modules or units including a survival state information acquisition module 610, a current system information acquisition module 612, a service node abnormality determining module 614, a central state information acquisition module 616, and an abnormal service node processing module 618.

The survival state information acquisition module 610 is configured to acquire survival state information of the service node.

In an example embodiment of the present disclosure, the distributed system includes a state information table, and the survival state information acquisition module 301 may include the following sub-modules:

a survival state information receiving sub-module configured to receive the survival state information uploaded by the service nodes; and

a first state information table update sub-module configured to update the state information table by using the survival state information of the service nodes.

The current system information acquisition module 612 is configured to acquire current system information of the central node.

The service node abnormality determining module 614 is configured to determine, by using the survival state information and the current system information, whether there is an abnormality of the service node; and call a central state information acquisition module if there is an abnormality of the service node.

In an example embodiment of the present disclosure, the survival state information includes a next update time of the service node, the current system information includes a current system time of the central node, and the service node abnormality determining module 303 may include the following sub-modules:

a state information table traversing sub-module configured to traverse next update times in the state information table when a preset time arrives; and

a service node abnormality determining sub-module configured to determine whether there is an abnormality of the service node by using the next update times and the current system time.

In an example embodiment of the present disclosure, the service node abnormality determining sub-module includes:

a time determination unit configured to determine whether the next update time is less than the current system time; if yes, call a first determining unit; and if no, call a second determining unit;

the first determining unit configured to determine that there is an abnormality of the service node; and

the second determining unit configured to determine that there is no abnormality of the service node.

The central state information acquisition module 616 is configured to acquire the central state information of the central node.

The abnormal service node processing module 618 is configured to process the abnormal service node according to the central state information.

In an example embodiment of the present disclosure, the central state information includes network busyness status data and/or system resource usage status data, and the abnormal service node processing module 618 includes:

a central node state determining sub-module configured to determine, by using the network busyness status data and/or the system resource usage status data, whether the central node is overloaded; and if yes, call a second state information table update sub-module; and

the second state information table update sub-module configured to update the survival state information of the abnormal service node in the state information table.

In an example embodiment of the present disclosure, the network busyness status data includes network throughput, the system resource usage status data includes an average load of the system, and the central node state determining sub-module includes:

a first network busyness status determination unit configured to determine whether the network throughput is greater than or equal to a network bandwidth;

a second network busyness status determination unit configured to determine whether the network packet loss rate is greater than a preset packet loss rate;

a system resource usage status determination unit configured to determine whether the average load of the system is greater than a preset load threshold; and

a central node load determining unit configured to determine that the central node is overloaded when the network throughput is greater than or equal to the network bandwidth, and/or the network packet loss rate is greater than the preset packet loss rate, and/or the average load of the system is greater than the preset load threshold.

In an example embodiment of the present disclosure, the second state information table update sub-module includes:

a next update time extension unit configured to extend the next update time of the abnormal service node in the state information table.

In another example embodiment of the present disclosure, the second state information table update sub-module includes:

an update request sending unit configured to send an update request to the service node;

a next update time receiving unit configured to receive new survival state information that is uploaded by the service node with respect to the update request, the new survival state information comprising a new next update time; and a next update time updating unit configured to update the next update time of the abnormal service node in the state information table by using the new next update time.

In an example embodiment of the present disclosure, the apparatus further includes:

a failed service node determining module configured to use the service node as a failed service node when there is no abnormality of the service node.

In an example embodiment of the present disclosure, the apparatus further includes:

a failed service node deletion module configured to delete the failed service node from the central node; and

a failed service node notification module configured to notify other service nodes in the distributed system of the failed service node.

The apparatus example embodiment is basically similar to the method example embodiment, and therefore is described in a relatively simple manner. For related parts, reference may be made to the partial description of the method example embodiment.

The example embodiments in the specification are described progressively. Each example embodiment focuses on a difference from other example embodiments. For identical or similar parts of the example embodiments, reference may be made to each other.

Those skilled in the art should understand that the example embodiment of the present disclosure may be provided as a method, an apparatus, or a computer program product. Therefore, the example embodiment of the present disclosure may be implemented as a complete hardware example embodiment, a complete software example embodiment, or an example embodiment combining software and hardware. Moreover, the example embodiment of the present disclosure may be in the form of a computer program product implemented on one or more computer usable storage media (including, but not limited to, a magnetic disk memory, a CD-ROM, an optical memory, and the like) including computer usable program codes.

In a typical configuration, the computer device includes one or more processors (CPU), an input/output interface, a network interface, and a memory. The memory may include a volatile memory, a random access memory (RAM) and/or a non-volatile memory or the like in a computer readable medium, for example, a read-only memory (ROM) or a flash RAM. The memory is an example of the computer readable medium. The computer readable medium includes non-volatile and volatile media as well as movable and non-movable media, and may implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and may be used to store information accessible to the computing device. According to the definition in this text, the computer readable medium does not include transitory media, such as modulated data signals and carriers.

The example embodiments of present disclosure are described with reference to flowcharts and/or block diagrams according to the method, the terminal device (system), and the computer program product of the example embodiments of the present disclosure. It should be understood that a computer program instruction may be used to implement each process and/or block in the flowcharts and/or block diagrams and combinations of processes and/or blocks in the flowcharts and/or block diagrams. The computer-readable instructions may be provided to a general-purpose computer, a special-purpose computer, an embedded processor or a processor of another programmable data processing terminal device to generate a machine, such that the computer or the processor of another programmable data processing terminal device executes an instruction to generate an apparatus configured to implement functions designated in one or more processes in a flowchart and/or one or more blocks in a block diagram.

The computer-readable instructions may also be stored in a computer readable memory that may guide the computer or another programmable data processing terminal device to work in a specific manner, such that the instruction stored in the computer readable memory generates an article of manufacture including an instruction apparatus, and the instruction apparatus implements functions designated by one or more processes in a flowchart and/or one or more blocks in a block diagram.

The computer-readable instructions may also be loaded into a computer or another programmable data processing terminal device, such that a series of operation steps are executed on the computer or another programmable terminal device to generate computer-implemented processing. Therefore, the instruction executed in the computer or another programmable terminal device provides steps for implementing functions designated in one or more processes in a flowchart and/or one or more blocks in a block diagram.

Although example embodiments of the example embodiments of the present disclosure have been described, those skilled in the art may make other changes and modifications to these example embodiments once knowing the basic inventive concept. Therefore, the appended claims are intended to be interpreted as including the example embodiments and all changes and modifications falling into the scope of the example embodiments of the present disclosure.

Finally, it should be further noted that relational terms such as “first” and “second” in this text are only used for distinguishing one entity or operation from another entity or operation, but does not necessarily require or imply any such actual relations or sequences between these entities or operations. Moreover, the terms “include”, “comprise” or other variations thereof are intended to cover a non-exclusive inclusion, so that a process, method, article or terminal device including a series of elements not only includes the elements, but also includes other elements not clearly listed, or further includes elements inherent to the process, method, article or terminal device. In the absence of more limitations, an element defined by “including a/an . . . ” does not exclude that the process, method, article or terminal device including the element further has other identical elements.

A method for processing nodes in a distributed system and an apparatus for processing nodes in a distributed system provided in the present disclosure are described above in detail. Specific examples are used in the text to illustrate the principle and implementations of the present disclosure, and the description of the example embodiments above is merely used to help understand the method of the present disclosure and its core idea. Meanwhile, those of ordinary skill in the art may change the specific implementations and application ranges according to the idea of the present disclosure. In conclusion, the content of the specification should not be construed as a limitation to the present disclosure.

What is claimed is:

1. A method comprising:
acquiring survival state information of a service node in a distributed system;
acquiring current system information of a central node in the distributed system;
determining, by using the survival state information and the current system information, that there is an abnormality of the service node;
acquiring central state information of the central node; and
processing the service node according to the central state information.

2. The method of claim 1, wherein
the distributed system comprises a state information table; and
the acquiring the survival state information of the service node comprises:
receiving the survival state information uploaded by the service node; and
updating the state information table by using the survival state information of the service node.

3. The method of claim 1, wherein:
the survival state information comprises a next update time of the service node;
the current system information comprises a current system time of the central node; and
the determining, by using the survival state information and the current system information, that there is the abnormality of the service node comprises:
traversing to find the next update times of the service node in the state information table when a preset time arrives; and
determining, by using the next update time and the current system time, that there is the abnormality of the service node.

4. The method of claim 3, wherein the determining, by using the next update times and the current system time, that there is the abnormality of the service node comprises:
determining that the next update time is less than the current system time; and
determining that there is the abnormality of the service node.

5. The method of claim 1, wherein:
the central state information comprises network busyness status data; and
the processing the service node according to the central state information comprises:
determining, by using the network busyness status data, that the central node is overloaded; and
updating the survival state information of the service node in the state information table.

6. The method of claim 5, wherein:
the network busyness status data comprises a network throughput; and
the determining, by using the network busyness status data, that the central node is overloaded comprises determining that the network throughput is greater than or equal to a network bandwidth.

7. The method of claim 5, wherein:
the network busyness status data comprises a network packet loss rate; and
the determining, by using the network busyness status data, that the central node is overloaded comprises determining that the network packet loss rate is greater than a preset packet loss rate.

8. The method of claim 1, wherein:
the central state information comprises system resource usage status data; and
the processing the service node according to the central state information comprises:
determining, by using the system resource usage status data, that the central node is overloaded; and
updating the survival state information of the service node in the state information table.

9. The method of claim 8, wherein:
the system resource usage status data comprises an average load of the system; and
the determining, by using the system resource usage status data, that the central node is overloaded comprises determining that the average load of the system is greater than a preset load threshold.

10. The method of claim 8, wherein the updating the survival state information of the service node in the state information table comprises:
extending a next update time of the service node in the state information table.

11. The method of claim 8, wherein the updating the survival state information of the service node in the state information table comprises:
sending an update request to the service node;
receiving new survival state information that is uploaded by the service node with respect to the update request, the new survival state information comprising a new next update time; and
updating a next update time of the service node in the state information table by using the new next update time.

12. The method of claim 1, further comprising:
treating the service node as a failed service node in response to determining that there is abnormality of the service node.

13. The method of claim 12, further comprising:
deleting the failed service node from the central node; and
notifying other service nodes in the distributed system of the failed service node.

14. An apparatus comprising:
one or more processors; and
one or more memories storing thereon computer-readable instructions that, when executed by the one or more processors, cause the one or more processors to perform acts comprising:
acquiring survival state information of a service node in a distributed system;
acquiring current system information of a central node in the distributed system; and
determining, by using the survival state information and the current system information, that there is an abnormality of the service node.

15. The apparatus of claim 14, wherein:
the survival state information comprises a next update time of the service node;
the current system information comprises a current system time of the central node; and
the determining, by using the survival state information and the current system information, that there is the abnormality of the service node comprises:
traversing to find the next update times of the service node in the state information table when a preset time arrives; and
determining, by using the next update time and the current system time, that there is the abnormality of the service node.

16. The apparatus of claim 15, wherein the determining, by using the next update times and the current system time, that there is the abnormality of the service node comprises:
determining that the next update time is less than the current system time; and
determining that there is the abnormality of the service node.

17. The apparatus of claim 14, wherein the acts further comprise:
acquiring central state information of the central node; and
processing the service node according to the central state information.

18. The apparatus of claim 17, wherein:
the central state information comprises network busyness status data and/or system resource usage status data; and
the processing the service node according to the central state information comprises:
determining, by using the network busyness status data or the system resource usage status data, that the central node is overloaded; and
updating the survival state information of the service node in the state information table.

19. The apparatus of claim 18, wherein:
the network busyness status data comprises a network throughput and a network packet loss rate;
the system resource usage status data comprises an average load of the system; and
the determining, by using the network busyness status data or the system resource usage status data, that the central node is overloaded comprises:
determining whether the network throughput is greater than or equal to a network bandwidth;
determining whether the network packet loss rate is greater than a preset packet loss rate;
determining whether the average load of the system is greater than a preset load threshold; and
determining that the central node is overloaded in response to determining that the network throughput is greater than or equal to the network bandwidth, the network packet loss rate is greater than the preset packet loss rate, or the average load of the system is greater than the preset load threshold.

20. One or more memories storing thereon computer-readable instructions that, when executed by one or more processors, cause the one or more processors to perform acts comprising:
acquiring survival state information of a service node in a distributed system, the survival state information including a next update time of the service node;
acquiring current system information of a central node in the distributed system, the current system information including a current system time of the central node;
determining that the next update time is less than the current system time; and
determining that there is the abnormality of the service node.
